(19) United States
(12) Patent Application Publication
(10) Pub. No.: US 2010/0006622 A1
(43) Pub. Date: Jan. 14, 2010

(54) SELF-CLAMPING FRICTION STIR WELDING DEVICE

(76) Inventors: Christopher B. Smith, Milwaukee, WI (US); Scott M. Gillis, Waukesha, WI (US); Lee M. Cerveny, New Berlin, WI (US)

Correspondence Address: MICHAEL BEST & FRIEDRICH LLP, 100 E WISCONSIN AVENUE, Suite 3300, MILWAUKEE, WI, 53202, US

(21) Appl. No.: 12/500,879

(22) Filed: Jul. 10, 2009

Related U.S. Application Data
(60) Provisional application No. 61/079,605, filed on Jul. 10, 2008.

(51) Int. Cl. B23K 20/12

(52) U.S. Cl. 228/2.1

(57) ABSTRACT

A friction stir welding device operable to weld a joint formed between a first workpiece and a second workpiece. The friction stir welding device includes a clamping device coupled to a tool body of the welding device for movement with the tool body along the joint. The clamping device includes a first guide member and a second guide member. The first guide member includes a clamping face configured to engage the first workpiece and the second guide member includes a clamping face configured to engage the second workpiece. The clamping face of the first guide member is directly opposed to the clamping face of the second guide member to resist separation of the joint.

### CROSS REFERENCE TO RELATED APPLICATIONS

This application claims priority to U.S. Provisional Patent Application No. 61/079,605, filed Jul. 10, 2008, the entire contents of which are hereby incorporated by reference herein.

### BACKGROUND

The present invention relates to a friction stir welding device for welding workpieces together, and more particularly to a friction stir welding device that clamps workpieces together.

The process of friction stir welding is used for joining workpieces disposed adjacent to one another. The friction stir welding device includes a rotatable shaft with a free end including a shoulder and a pin-like projection that extends from the shoulder. To form a weld, the pin is rotated at a predetermined speed and is forced along a joint between the workpieces. Friction between the rotating tool and the workpieces plasticizes and softens the metal in a weld region surrounding the pin. As the pin translates along the joint of the workpieces, hot, plasticized metal from the workpieces mixes together to form a welded joint and thereby attaches the workpieces together.

Generally, large, complex and unwieldy clamping systems or fixtures are used to hold the workpieces in place during welding. The friction stir welding process generates forces in a downward direction along the axis of rotation of the pin, and in a transverse direction perpendicular to the joint between the workpieces. The forces may cause joint separation or buckling of the workpieces.

### SUMMARY

In one embodiment, the invention provides a friction stir welding device that is operable to weld a joint having a length. The joint is formed between a first workpiece and a second workpiece. The friction stir welding device includes a tool body configured to move along the length of the joint and a shaft having a longitudinal axis. The shaft is coupled to the tool body for movement with the tool body along the length of the joint and for rotation with respect to the tool body about the longitudinal axis. A weld tool is coupled to the shaft for rotation with the shaft and coupled to the tool body for movement with the tool body along the length of the joint. The weld tool is configured to rotate with respect to the first workpiece and the second workpiece to weld the joint. A clamping device is coupled to the tool body for movement with the tool body along the length of the joint. The clamping device includes a first guide member and a second guide member. The first guide member includes a clamping face configured to engage the first workpiece and the second guide member includes a clamping face configured to engage the second workpiece. The clamping face of the first guide member is directly opposed to the clamping face of the second guide member to resist separation of the joint.

In another embodiment the invention provides a friction stir welding device that is operable to weld a joint having a length. The joint is formed between a first workpiece and a second workpiece. The friction stir welding device includes a tool body configured to move along the length of the joint and a shaft having a longitudinal axis. The shaft is coupled to the tool body for movement along the length of the joint and for rotation with respect to the tool body about the longitudinal axis. A weld tool is coupled to the shaft for rotation with the shaft and coupled to the tool body for movement with the tool body along the length of the joint. The weld tool is configured to rotate with respect to the first workpiece and the second workpiece to weld the joint. A clamping device is coupled to the tool body for movement with the tool body along the length of the joint. The clamping device includes a first guide member located along a first side of the weld tool and having a roller configured to engage the first workpiece to resist separation of the joint. The roller of the first guide member is rotatable about an axis substantially parallel to the longitudinal axis of the shaft. The clamping device further includes a second guide member located along a second side of the weld tool that is opposite the first side of the weld tool. The second guide member includes a roller configured to engage the second workpiece to resist separation of the joint, and the roller of the second guide member is rotatable about an axis substantially parallel to the longitudinal axis of the shaft. A support member extends from the first guide member to the second guide member, and the support member is configured to absorb vertical weld forces incurred by the weld tool during operation of the friction stir welding device.

In another embodiment the invention provides a friction stir welding device operable to weld a joint having a length. The joint is formed between a first workpiece and a second workpiece. The friction stir welding device includes a tool body configured to move along the length of the joint and a shaft having a longitudinal axis. The shaft is coupled to the tool body for movement along the length of the joint with the tool body and for rotation with respect to the tool body about the longitudinal axis. A weld tool is coupled to the shaft for rotation with the shaft and coupled to the tool body for movement with the tool body along the length of the joint. The weld tool is configured to rotate with respect to the first workpiece and the second workpiece to weld the joint. A clamping device is coupled to the tool body for movement with the tool body along the length of the joint. The clamping device includes a guide member. The guide member includes a clamping face adjacent the weld tool, and the clamping face is configured to engage the first workpiece to resist separation of the joint. The clamping face of the guide member is substantially parallel to the longitudinal axis of the shaft.

Other aspects of the invention will become apparent by consideration of the detailed description and accompanying drawings.

### BRIEF DESCRIPTION OF THE DRAWINGS

FIG. 1 is a perspective view of a self-clamping friction stir welding device according to one embodiment of the invention.

FIG. 2 is a perspective view of a portion of the self-clamping friction stir welding device shown in FIG. 1.

FIG. 3 is an end view of the self-clamping friction stir welding device shown in FIG. 1.

FIG. 4 is a perspective view of a T-shaped beam.

FIG. 5 is a perspective view of a T-shaped beam including an integral track.

FIG. 6 is a perspective view of a panel including the T-shaped beams shown in FIGS. 4 and 5.

FIG. 7 is a perspective view of a plurality of the panels shown in FIG. 6, and assembled using the self-clamping friction stir welding device shown in FIG. 1.

FIG. 8 is a perspective view of a stiffener.

FIG. 9 is a perspective view of a plurality of the panels shown in FIG. 6 assembled using the self-clamping friction stir welding device shown in FIG. 1, and including a plurality of the stiffeners shown in FIG. 8.

FIG. 10 is a perspective view of a corner beam including a pair of tracks.

FIG. 11 is a perspective view of a plurality of the panels shown in FIG. 6, and including the stiffener shown in FIG. 8 and the corner beam shown in FIG. 10.

FIG. 12 is a perspective view of a plurality of the panels shown in FIG. 11, and assembled with the corner beam shown in FIG. 10 to form a multi-sided structure.

FIG. 13 is a perspective view of a T-shaped beam including a plurality of tracks.

FIG. 14 is a perspective view of a plurality of the panels shown in FIG. 11, and assembled with the corner beam shown in FIG. 10 and the T-shaped beam shown in FIG. 13.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

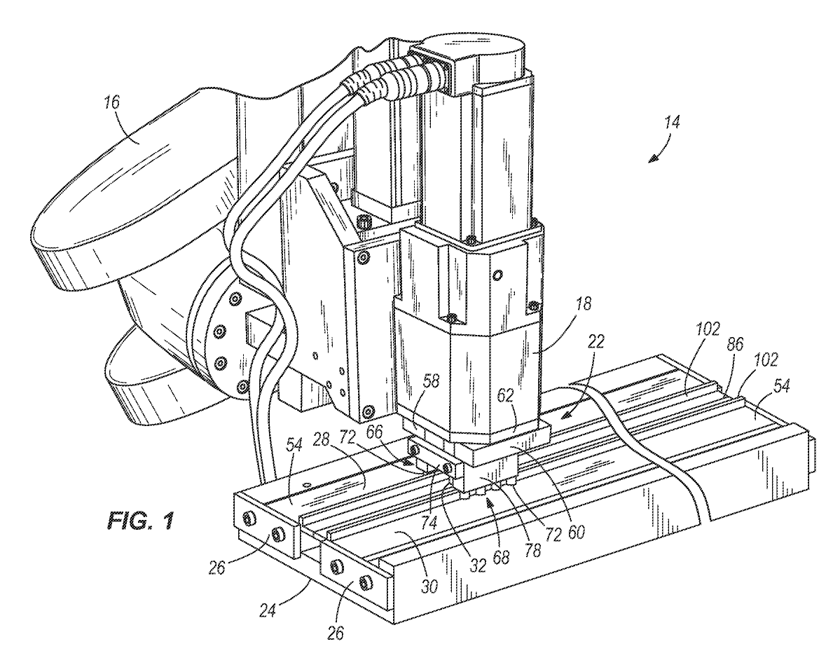

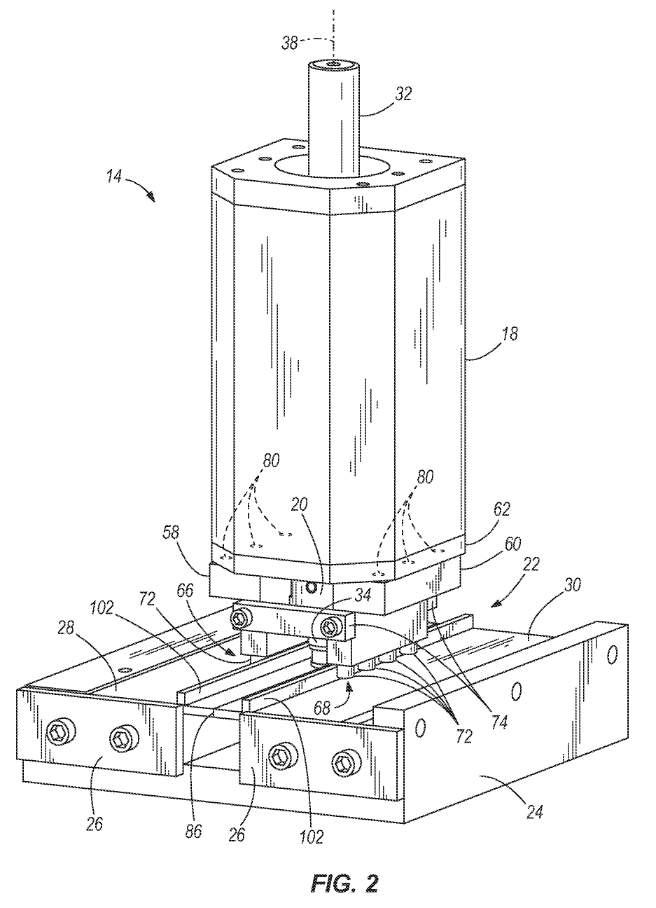

FIGS. 1 and 2 illustrate a self-clamping friction stir welding device 14 according to one embodiment of the invention. In the illustrated embodiment the friction stir welding device 14 is mounted to a friction stir welding machine 16. The welding device 14 may be used with a robotic, a non-robotic, or other types of friction stir welding machines, including manual machines. The self-clamping friction stir welding device 14 includes a spindle or tool body 18, a tool holder 20 coupled to the spindle 18, and a clamping system or clamping device 22, coupled to the spindle 18. A base 24 and workpiece supports 26 (or backings) supported by the base 24 support a first workpiece 28 and a second workpiece 30 to be friction stir welded by the device 14. In the illustrated embodiment, the workpieces 28, 30 are substantially identical workpieces, and the workpieces 28 and 30 will be discussed in more detail below.

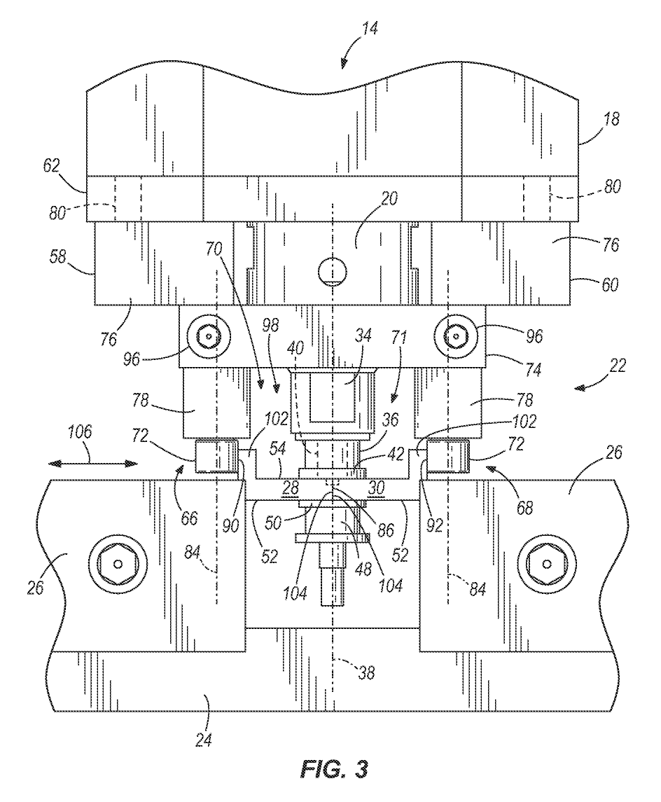

Referring to FIGS. 2 and 3, the spindle 18 includes a rotatable shaft 32 (FIG. 2) that extends through the spindle 18 and includes a tool end 34. A weld tool 36 is coupled to the tool end 34 of the shaft 32, via the tool holder 20, and rotates with the shaft 32 about a rotational or longitudinal axis 38. Accordingly, the shaft 32 is coupled to the spindle 18 for rotation with respect to the spindle 18 about the axis 38, and the shaft 32 is coupled for movement with the tool body along the workpieces 28, 30. In FIGS. 2 and 3, the longitudinal axis 38 is oriented along a vertical axis; however, in other embodiments, the longitudinal axis 38 may be oriented along various axes. As best seen in FIG. 3, the weld tool 36 includes a weld pin 40 coupled to and extending from a shoulder 42 defined by the weld tool 36. The weld pin 40 defines a contact surface for the weld tool 36. In some embodiments, the weld pin 40 may be formed as one part with the weld tool 36. In other embodiments, the weld tool 36 and the weld pin 40 may be formed as separate parts.

In the illustrated embodiment, a self-reacting tool 48 is used with the self-clamping friction stir welding device 14. The self-reacting tool 48 is positioned between the workpiece supports 26 and includes a shoulder 50 that is positionable against second or bottom surfaces 52 of adjoining workpieces 28, 30. The shoulders 42, 50 of the weld tool 36 and the self-reacting tool 48, respectively, may abut and translate across first or top surfaces 54 and the second surfaces 58, respectively, of adjoining workpieces 28, 30, as shown in FIG. 3. In further embodiments, the self-clamping friction stir welding device 14 may be utilized without the self-reacting tool 48.

Referring to FIGS. 2 and 3, the clamping system 22 includes a pair of mounting members 58, 60 coupled to a mounting plate 62 of the spindle 18. A first guide member 66 is coupled to the mounting member 58 adjacent the weld tool 36 along a first side 70 of the weld tool 36 and a second guide member 68 is coupled to the mounting member 60 adjacent the weld tool 36 along a second side 71 of the weld tool 36, which is opposite the first side 70. The illustrated guide members 66, 68 each include rollers 72 coupled to respective mounting members 58, 60. Bars or support members 74 extend between the mounting members 58, 60. In other embodiments, the clamping system 22 may include fewer or more rollers 72 such that at least two rollers are coupled to each mounting member 58, 60. In yet other embodiments, the clamping system 22 may include only one of the guide members 66 or 68.

Each mounting member 58, 60 includes an upper portion 76 and a lower portion 78. The upper portion 76 of each mounting member 58, 60 is coupled to the mounting plate 62 with fasteners 80, which include bolts in the illustrated embodiment. Each roller 72 includes a threaded shaft (not shown), and is coupled to the lower portion 78 of the respective mounting member 58, 60 via the threaded shaft. In the illustrated embodiment, the rollers 72 may rotate about respective axes 84, which are generally parallel to the rotational axis 38 of the shaft 32. The rollers 72, and therein the roller axes 84, of each mounting member 58,60 are arranged in respective lateral, parallel rows to clamp adjacent workpieces 28, 30 together and resist separation of a joint 86 formed between the workpieces 28, 30. As best seen in FIG. 3, the rollers 72 of the first guide member 66 define a clamping face 90 and the rollers 72 of the second guide member 68 define a clamping face 92. The clamping face 90 of the first guide member 66 faces toward and directly opposes the clamping face 92 of the second guide member 68. Also, the clamping faces 90, 92 are parallel to the longitudinal axis 38 of the shaft 32. The clamping faces 90, 92 are directly opposed and face each other to resist separation of the joint 86 between the workpieces 28, 30 during operation of the welding device 14.

The rollers 72 can also guide and direct the friction stir welding device 14 along a path defined by the joint 86. Each bar 74 extends between the lower portions 78 of the mounting members 58, 60, proximate to the upper portions 76, and is coupled to the mounting members 58, 60 via fasteners 96, which include bolts in the illustrated embodiment. The mounting members 58, 60 are spaced apart from one another and define an interior area 98 for accommodating the shaft 32, the tool holder 20 and the weld tool 36.

In some embodiments, each roller 72 is threaded into a respective threaded aperture formed in the mounting members 58, 60. In other embodiments, the rollers 72 are coupled to the mounting members 58, 60 by threading a nut onto the threaded shaft of each roller 72. In yet other embodiments, various other guide members may be coupled to or integrally formed with the mounting members 58, 60 to hold and maintain the workpieces 28, 30 against one another and the joint 86 formed therebetween. These guide members may be made of a low friction material and/or provide a frictionless surface. Examples of such structures may include a plate, a belt, a band, a slug or a stop member.

Each of the workpieces 28, 30 includes a track 102, which in the illustrated embodiment provides a rib-like structure. Each track 102 extends along a length of the workpiece 28, 30 proximate or adjacent a joint edge 104 of the workpieces 28, 30. In other embodiments, the track 102 may comprise various protruding structures of various shapes integrally formed with the workpiece 28, 30. In yet other embodiments, the track 102 may be a groove or channel recessed from the first surface 54 of the workpieces 28, 30. In yet other embodiments, the track can be formed by a separate hardware component that is coupled to the workpiece. As shown in FIGS. 2 and 3, the tracks 102 provide a structure for the rollers 72 to engage and to push against to resist separation of the joint 86.

In other embodiments, the workpieces 28, 30 may be various extrusions having a variety of shapes (e.g., flat, curved, angled, etc), and include the track 102, which may be integrally formed with or coupled to the extrusion. For example, the self-clamping friction stir welding device 14 may be used to weld joints formed by workpieces, such as, I-beams and/or flat extrusions. In yet other embodiments, the self-clamping friction stir welding device 14 may be used to weld joints formed by combinations of workpieces, including workpieces made in other various manufacturing processes.

During operation of the self-clamping friction stir welding device 14, the workpieces 28, 30 are clamped together by the clamping system 22 to prevent separation of the joint 86 to be welded. The mounting members 58, 60 are spaced apart from one another such that the rollers 72 prevent the workpieces 28, 30 from transversely separating during the friction stir welding process. To clamp the workpieces 28, 30 together, the rollers 72 are placed against the tracks 102 of each workpiece 28, 30 such that the rollers 72 push the workpieces 28, 30 together or resist separation of the workpieces 28, 30, in a transverse direction 106 (FIG. 3), to form and maintain the joint 86 therebetween. In the illustrated embodiment, the rollers 72 of the clamping system 22 rotate about axes 84, which are substantially parallel to the longitudinal axis 38 of the shaft 32. The rollers 72 translate with respect to the tracks 102 and roll along the tracks 102 to provide local transverse fixturing and clamping as the welding device 14 moves along the workpieces 28, 30 and the joint 86. The bars 74 absorb transverse weld forces incurred by the weld tool 36 during the friction stir welding process. In some embodiments, the bars 74 of the roller system 22 may hold the rollers 72 against the tracks 102 of the adjacent workpieces 28, 30. In other embodiments, the bars 74 may also help maintain the transverse distance between the mounting members 58, 60, and therein the adjacent tracks 102 as well as the shaft 32 to the joint 86.

During the friction stir welding process, the friction stir welding machine 16 (FIG. 1) moves the weld tool 36 of the self-clamping friction stir welding device 14 along the workpieces 28, 32 such that the weld tool 36 friction stir welds the joint 86 therebetween. Generally, the weld tool 36, using the weld pin 40, mechanically mixes or stirs the material of both workpieces 28, 30 together to form a weld, or a welded joint, along adjacent edges 104 of the workpieces 28, 30. The shoulder 42 of the weld tool 36 pushes on the first surfaces 54 of the workpieces 28, 30 and the shoulder 50 of the self-reacting tool 48 pushes on the second surfaces 52 of the workpieces 28, 30 to provide local vertical fixturing and clamping (as oriented in the illustrated embodiment). As indicated above, the self-clamping friction stir welding device 14 may be used without the self-reacting tool 48. In the illustrated embodiment, the self-reacting tool 48 absorbs and opposes the vertical weld forces incurred by the weld tool 36 during the friction stir welding process. In addition, by absorbing the transverse and vertical weld forces, the clamping system 22 and the self-reacting tool 48, respectively, allow the net load or force on the self-clamping friction stir welding device 14 to be approximately zero during the friction stir welding process.

The self-clamping friction stir welding device 14 provides a friction stir welding tool and a local clamping device. Therefore, the self-clamping friction stir welding device 14 reduces or eliminates the requirement of conventional fixturing or clamping. In addition, the self-clamping friction stir welding device 14, including the clamping system 22, is usable in applications with little access to the second surface 52 of the workpieces 28, 30.

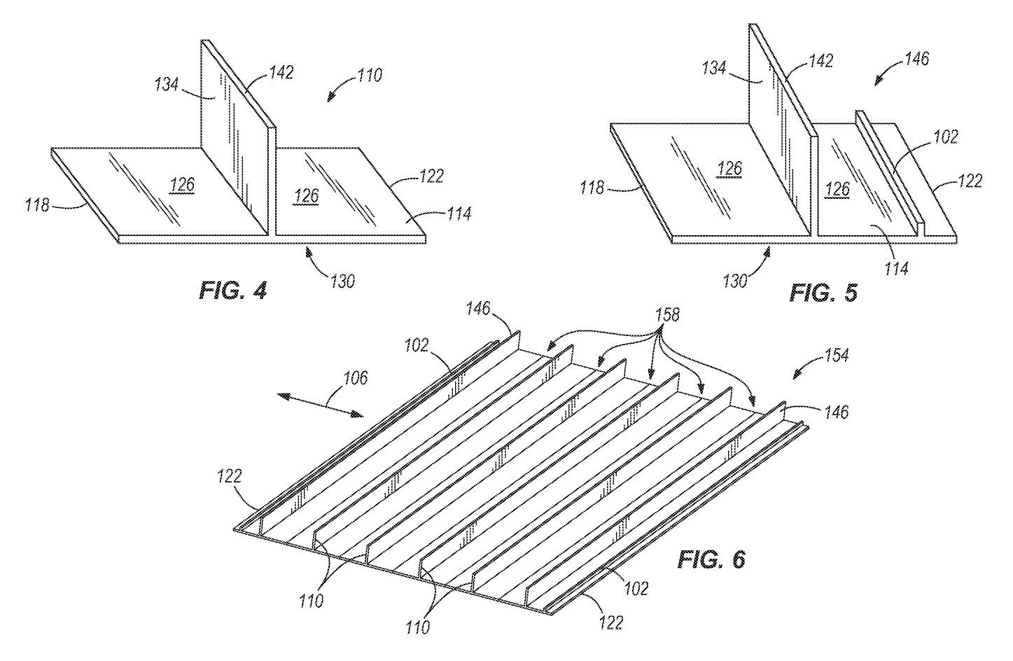

FIGS. 4-14 illustrate examples of workpieces that may be utilized with the self-clamping friction stir welding device 14 shown in FIGS. 1 and 2.

FIG. 4 illustrates a T-shaped workpiece or beam 110. The beam 110 includes a base 114 having a pair of side edges (i.e., a first side edge 118 and a second side edge 122), and a pair of opposite surfaces (i.e., a first surface 126 and a second surface 130) extending between the first and second side edges 118, 122. The beam 110 also includes a web 134 that is integrally formed with the base 114 and includes a side edge 142. The web 134 extends perpendicular to and centrally from the first surface 126 of the base 114. In other embodiments, the web 134 extends at various angles with respect to the base 114, and in yet other embodiments the web 134 may have other shapes. In some embodiments, the rollers 72 of the clamping device 22 may contact the web 134 to guide movement of the spindle 18 along the beam 110 and clamp the beam 110 with another beam as the beams are welded. The beam 110 may be formed by, for example, hot rolling, cold rolling, extrusion, or other manufacturing processes such that the base 114 and the web 134 are formed as one part.

FIG. 5 illustrates another T-shaped workpiece or beam 146 that includes the track 102. The track beam 146 illustrated in FIG. 5 is similar to the beam 110 illustrated in FIG. 3; therefore, like structure will be identified by the same reference numerals. The track 102 is positioned proximate to the second side edge 122 of the base 114, and is integrally formed with and protrudes outwardly from the first surface 126 of the base 114. While the illustrated beams 146 and 110 are T-shaped, in further embodiments, the beams 146 and 100 may have other shapes, such as, the beams may be flat and not include the webs 134.

FIG. 6 illustrates a workpiece or panel 154 including four of the beams 110 (FIG. 4) and a pair of the track beams 146 (FIG. 5). In other embodiments, the panel 154 includes fewer or more than four of the beams 110. Each beam 110, 146 is coupled to another beam 110 by forming a joint 158 between the neighboring side edges 118, 122 of the adjacent beams 110, 146. The joints 158 formed between the four beams 110 and the two track beams 146 are welded using the friction stir welding process. Accordingly, the side edges 118, 122 of the adjacent beams 110, 146 are welded together such that the beams 110, 146 are parallel to one another and the first surface 126 of each beam 110, 146 faces in the same direction. The first side edges 118 of the pair of track beams 146 are welded to adjacent beams 110 such that the beams 110 are positioned between the two track beams 146.

In some embodiments, the panel 154 may include a substantial number of track beams 146 and may be assembled (i.e., welded) using the self-clamping friction stir welding device 14 shown in FIGS. 1 and 2 to reduce or eliminate the requirement of conventional fixturing and clamping. In other embodiments, the self-clamping friction stir welding device 14 may be used in combination with the conventional friction stir welding fixturing and clamping devices.

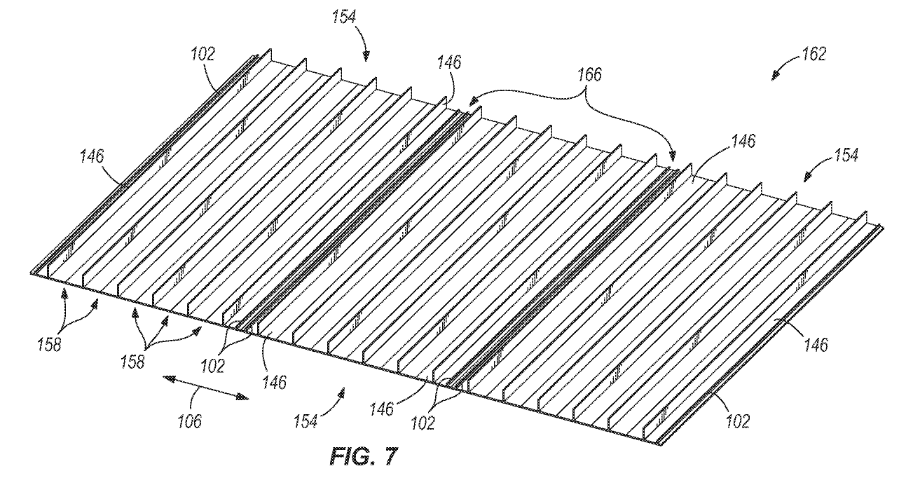

In some constructions, the friction stir welding device 14 may be used to assemble and weld large workpieces and panels, for example, welding panels that form walls or decking for ships or other vessels. FIG. 7 illustrates a large workpiece or panel 162 that includes three of the panels 154 shown in FIG. 6. To assemble the panel 162, joints 166 are formed between the adjacent panels 154 (i.e., at the track beams 146) and then welded using the self-clamping friction stir welding device 14 (FIGS. 1 and 2) and, when necessary, the self-reacting tool 48 (Fig. 3). Similar to the workpieces 28, 30 discussed above, adjacent panels 154 are clamped together by positioning the rollers 72 against the tracks 102 of the track beams 146 of adjacent panels 154 such that the rollers 72 push the track beams 146, and therein the panels 154, together to maintain contact and prevent separation of the panels 154 during welding.

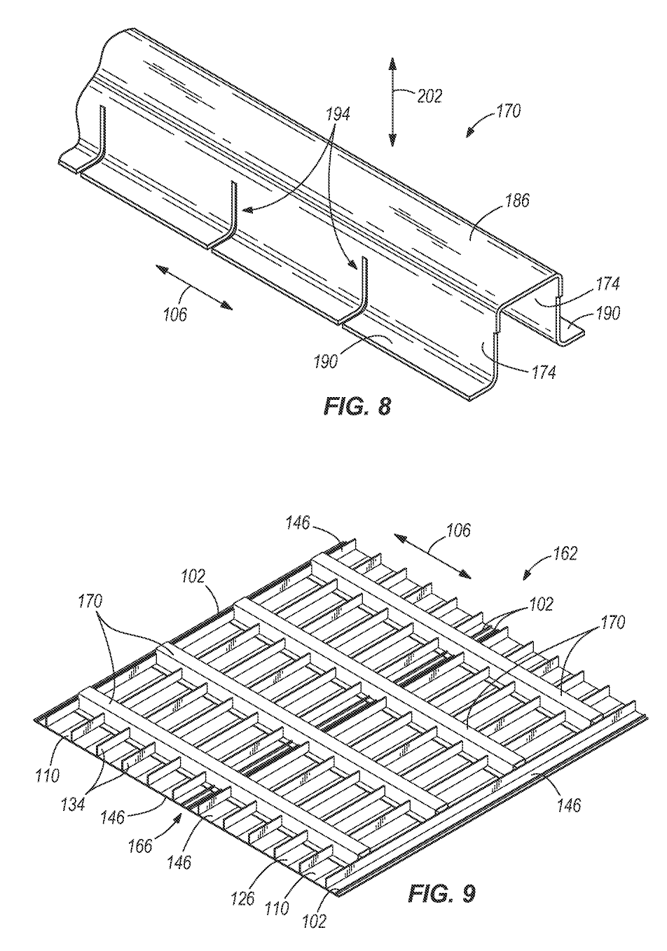

FIG. 8 illustrates a stiffener 170 for use with the panel 162. The stiffener 170 is generally U-shaped and includes outwardly extending flanges 190. In other embodiments, the stiffener 170 may not include the flanges 190 and may be formed as a variety of shapes and angles, such as a V-shape, a L-shape, or a T-shape. The U-shaped stiffener 170 includes a pair of side walls 174 and a base 186 extending between the walls 174. Notches 194 extend from the flanges 190, and toward and partially into the sides 174 in a direction perpendicular 202 to the base 186. The notches 194 are spaced apart in the transverse direction 106. As shown in FIG. 9, the transverse position of each notch 194 is defined by the position of the web 134 or a beam structure (e.g., the track 102) extending perpendicular from the first surface 126 of the each beam 110, 146.

FIG. 9 illustrates the panel 162, shown in FIG. 7, having two panels 154 and four of the stiffeners 170 shown in FIG. 8. The four stiffeners 170 provide reinforcement and added structural strength to the welded panel, specifically in the transverse direction 106. The stiffeners 170 are placed on the panel 162 such that the notches 194 of the stiffeners 170 receive the webs 134 of the beams 110, 146 and the tracks 102 of the beams 146. The stiffeners 170 are welded to the panel 162 using various conventional friction stir welding or other welding processes. In other constructions, the stiffeners 170 may be at least partially welded to the panel 162 using the self-clamping friction stir welding device 14 shown in FIGS. 1 and 2.

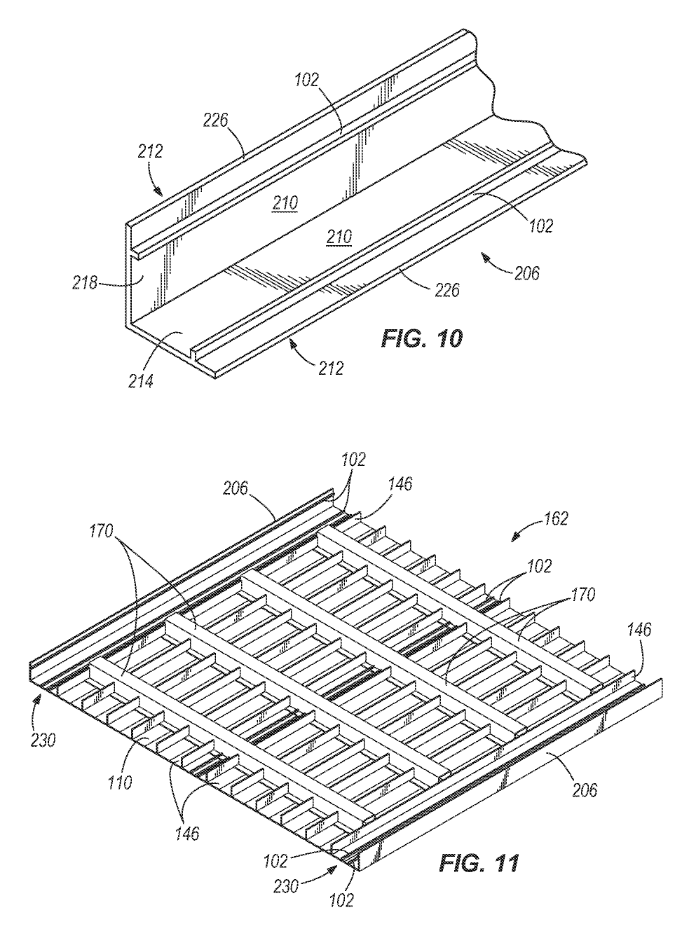

FIG. 10 illustrates a corner workpiece or L-shaped beam 206 including a pair of the tracks 102. The corner beam 206 includes a first side wall 214 and a second side wall 218, each having a side edge 226. In the illustrated construction, the second wall 218 is positioned perpendicular to, and is integrally formed with, the first wall 214. In other embodiments, the second wall 218 is positioned at various angles with respect to the first wall 214. Each wall 214, 218 includes a track 102 positioned proximate to the respective side edge 226. The tracks 102 are integrally formed with a first surface 210 of each wall 214, 218. In other embodiments, the tracks 102 may be integrally formed on a second surface 212 of either or both of the walls 214, 218. In other embodiments, the corner beam 206 may be other various shapes, such as curved or V-shaped.

FIG. 11 illustrates the corner beam 206 welded to the panel 162 shown in FIG. 9. To assemble the panel 162 with the corner beams 206, a joint 230 is formed between the side edge 226 of the corner beam 206 and the side edge 122 of the track beam 146 (FIG. 5). The rollers 72 of the self-clamping friction stir welding device 14 are used to push against the track 102 of the corner beam 206 and the track 102 of the track beam 146 to clamp the beams 206, 146 together along the joint 230 therebetween. The joints 230 are welded using the self-clamping friction stir welding device 14 shown in FIGS. 1 and 2. The panel 162 shown in FIG. 11 may be assembled with or without the stiffeners 170.

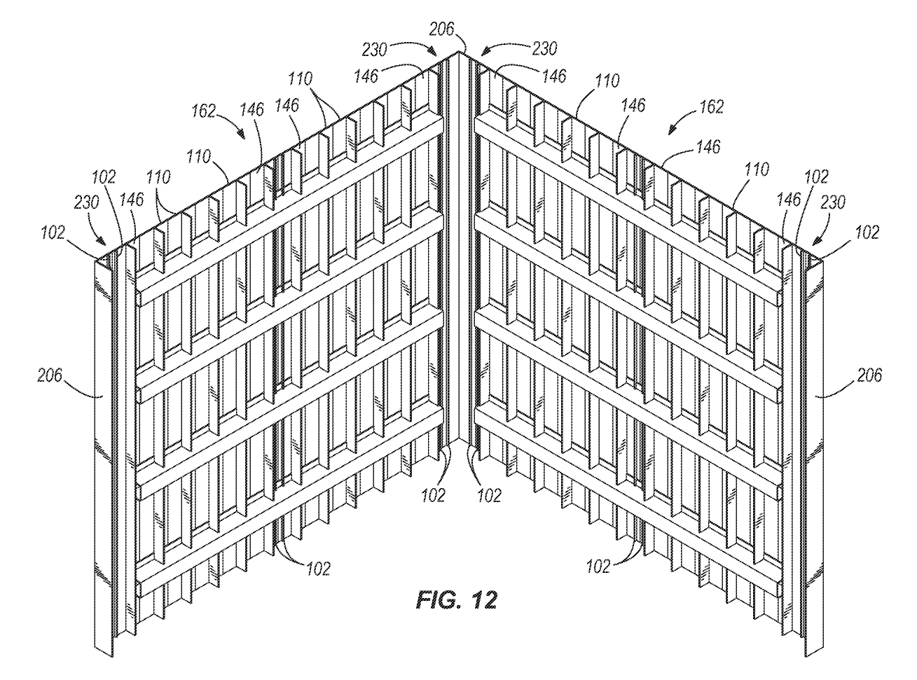

FIG. 12 illustrates two panels 162, shown in FIG. 11, assembled using at least one of the corner beams 206 shown in FIG. 10 to form two sides of a box-like structure. The self-clamping friction stir welding device 14 is used to push against the track 102 of the corner beam 206 and the track 102 of the adjacent track beam 146 to clamp the corner beam 206 to each panel 162 during welding. While FIG. 11 illustrates two sides of the box-like structure, two similar side panels 162 can be coupled to the corner beams 206 to form a four sided box-like structure.

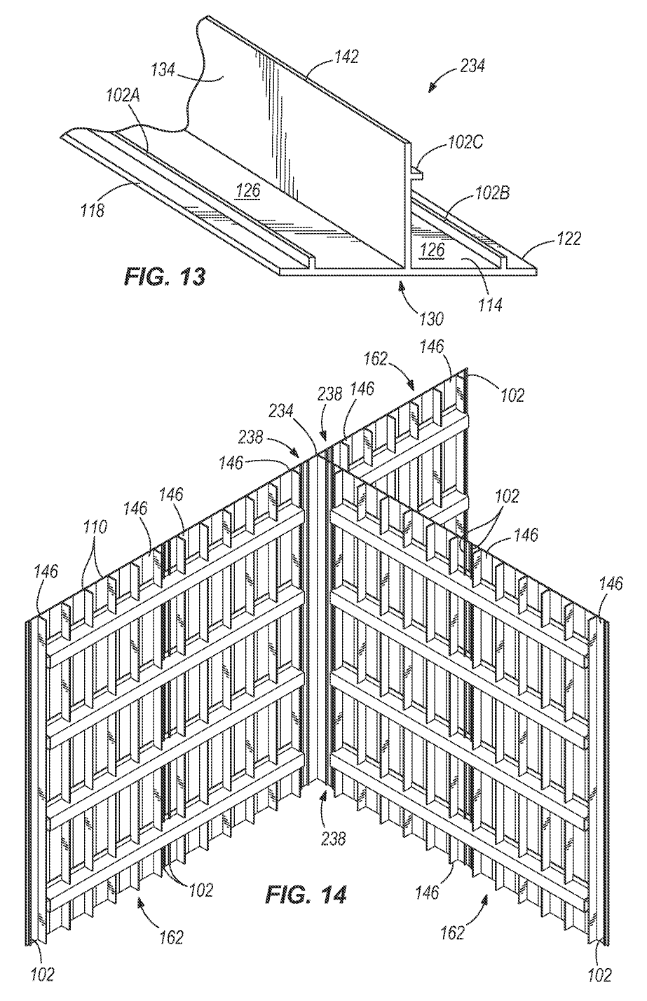

FIG. 13 illustrates another T-shaped workpiece or beam 234 including three of the tracks. The three-track beam 234 is similar to the track beam 146 shown in FIG. 4; therefore, like structure will be identified by the same reference numerals. The base 114 of the three-track beam 234 includes a pair of the tracks 102A, 102B positioned proximate to the first and second side edges 118, 122 respectively. The web 134 includes a third track 102C positioned proximate to the side edge 142 of the web 134. The first and second tracks 102A, 102B extend outwardly from the first surface 126 of the base 114, and the third track 102C extends outwardly from the web 134. In other embodiments, the third track 102C may be formed extending outwardly from either side of the web 134. In yet other embodiments, the web 134 may include a track 102 on both surfaces of the web 134.

FIG. 14 illustrates three panels 162 assembled using the three-track shaped beams 234, shown in FIG. 13. The self-clamping friction stir welding device 14 welds joints 238 formed between the three-track beam 234 and the adjacent track beams 146. Corner beams 206 (FIGS. 10 and 12) can be welded to free track beams 146 to form multiple box-like structures.

In other embodiments, the self-clamping friction stir welding device 14 may be used to weld any of the beams discussed herein and/or beams that are known in the art. Generally, these beams would be manufactured to include a clamping structure (e.g., a rib, a channel, a groove, etc.) to utilize the self-clamping feature of the friction stir welding device 14. However, in some embodiments, beams without a clamping structure would not utilize the self-clamping feature of the welding device 14. The self-clamping friction stir welding device 14 may be used to weld other joint edge shapes formed between adjacent beams. For example, adjacent beams may be clamped by the self-clamping friction stir welding device 14 to form joints that are straight and/or curved shaped.

Although the invention has been described in detail with reference to certain preferred embodiments, variations and modifications exist within the scope and spirit of one or more independent aspects of the invention as described.

What is claimed is:

1. A friction stir welding device operable to weld a joint having a length, the joint formed between a first workpiece and a second workpiece, the friction stir welding device comprising:
a tool body configured to move along the length of the joint;
a shaft having a longitudinal axis, the shaft coupled to the tool body for movement along the length of the joint with the tool body and for rotation with respect to the tool body about the longitudinal axis;
a weld tool coupled to the shaft for rotation with the shaft and coupled to the tool body for movement with the tool body along the length of the joint, the weld tool configured to rotate with respect to the first workpiece and the second workpiece to weld the joint; and
a clamping device coupled to the tool body for movement with the tool body along the length of the joint, the clamping device including a first guide member and a second guide member, wherein the first guide member includes a clamping face configured to engage the first workpiece and the second guide member includes a clamping face configured to engage the second workpiece, and wherein the clamping face of the first guide member is directly opposed to the clamping face of the second guide member to resist separation of the joint.

2. The friction stir welding device of claim 1, wherein the clamping face of the first guide member is parallel to the longitudinal axis of the shaft, and wherein the clamping face of the second guide member is parallel to the longitudinal axis of the shaft.

3. The friction stir welding device of claim 1, wherein the first guide member includes a roller that at least partially defines the clamping face of the first guide member, the roller rotatable about an axis, wherein the second guide member includes a roller that at least partially defines the clamping face of the second guide member, the roller rotatable about an axis, wherein the axis of the roller of the first guide member and the axis of the roller of the second guide member are parallel to the longitudinal axis of the shaft.

4. The friction stir welding device of claim 3, wherein the first guide member includes a second roller rotatable about an axis parallel to the longitudinal axis of the shaft, the second roller of the first guide member at least partially defining the clamping face of the first guide member, and further wherein the second guide member includes a second roller rotatable about an axis parallel to the longitudinal axis of the shaft, the second roller of the second guide member at least partially defining the clamping face of the second guide member.

5. The friction stir welding device of claim 1, wherein the first guide member is adjacent the weld tool along a first side of the weld tool and the second guide member is adjacent the weld tool along a second side of the weld tool that is opposite the first side of the weld tool.

6. The friction stir welding device of claim 1, further comprising a friction stir welding machine, wherein the tool body is coupled to the friction stir welding machine and the friction stir welding machine is operable to move the tool body along the length of the joint.

7. A friction stir welding device operable to weld a joint having a length, the joint formed between a first workpiece and a second workpiece, the friction stir welding device comprising:
a tool body configured to move along the length of the joint;
a shaft having a longitudinal axis, the shaft coupled to the tool body for movement along the length of the joint and for rotation with respect to the tool body about the longitudinal axis;
a weld tool coupled to the shaft for rotation with the shaft and coupled to the tool body for movement with the tool body along the length of the joint, the weld tool configured to rotate with respect to the first workpiece and the second workpiece to weld the joint; and
a clamping device coupled to the tool body for movement with the tool body along the length of the joint, the clamping device including,
a first guide member located along a first side of the weld tool and having a roller configured to engage the first workpiece to resist separation of the joint, the roller of the first guide member rotatable about an axis substantially parallel to the longitudinal axis of the shaft,
a second guide member located along a second side of the weld tool opposite the first side of the weld tool, the second guide member including a roller configured to engage the second workpiece to resist separation of the joint, the roller of the second guide member rotatable about an axis substantially parallel to the longitudinal axis of the shaft, and
a support member that extends from the first guide member to the second guide member, the support member configured to absorb vertical weld forces incurred by the weld tool during operation of the friction stir welding device.

8. The friction stir welding device of claim 7, wherein the first guide member includes a mounting member located along the first side of the weld tool, wherein the second guide member includes a mounting member located along the second side of the weld tool, wherein an interior area is defined between the mounting member of the first guide member and the mounting member of the second guide member such that a portion of the shaft is located within the interior area.

9. The friction stir welding device of claim 8, further comprising a tool holder coupled to the shaft, the tool holder coupling the weld tool to the shaft, and wherein the tool holder is located directly between the mounting member of the first guide member and the mounting member of the second guide member.

10. The friction stir welding device of claim 7, wherein first guide member includes a plurality of rollers configured to engage the first workpiece to resist separation of the joint, each of the plurality rollers of the first guide member rotatable about an axis substantially parallel to the longitudinal axis of the shaft, and further wherein the second guide member includes a plurality of rollers configured to engage the second workpiece to resist separation of the joint, each of the plurality of rollers of the second guide member rotatable about an axis substantially parallel to the longitudinal axis of the shaft.

11. The friction stir welding device of claim 7, wherein the roller of the first guide member defines a first clamping face that is parallel to the longitudinal axis of the shaft, and wherein the roller of the second guide member defines a second clamping face that is parallel to the longitudinal axis of the shaft.

12. A friction stir welding device operable to weld a joint having a length, the joint formed between a first workpiece and a second workpiece, the friction stir welding device comprising:
a tool body configured to move along the length of the joint;
a shaft having a longitudinal axis, the shaft coupled to the tool body for movement along the length of the joint with the tool body and for rotation with respect to the tool body about the longitudinal axis;
a weld tool coupled to the shaft for rotation with the shaft and coupled to the tool body for movement with the tool body along the length of the joint, the weld tool configured to rotate with respect to the first workpiece and the second workpiece to weld the joint; and
a clamping device coupled to the tool body for movement with the tool body along the length of the joint, the clamping device including a guide member, wherein the guide member includes a clamping face adjacent the weld tool, the clamping face configured to engage the first workpiece to resist separation of the joint, and wherein the clamping face of the guide member is substantially parallel to the longitudinal axis of the shaft.

13. The friction stir welding device of claim 12, wherein the guide member includes a roller that at least partially defines the clamping face, the roller rotatable about an axis, wherein the axis of the roller is substantially parallel to the longitudinal axis of the shaft.

14. The friction stir welding device of claim 12, further comprising the first workpiece and the second workpiece, wherein the first workpiece includes a track that extends along at least a portion of the length of the joint, the second workpiece configured to engage the first workpiece to define the joint having the length that extends along at least a portion of the length of the first workpiece and at least a portion of the length of the second workpiece, and wherein the guide member is configured to engage the track of the first workpiece to resist separation of the joint.

15. The friction stir welding device of claim 14, wherein the track of the first workpiece includes a rib.

16. The friction stir welding device of claim 14, wherein the track of the first workpiece is adjacent a joint edge of the first workpiece, wherein the second workpiece includes a joint edge, and wherein the joint edge of the first workpiece contacts the joint edge of the second workpiece to form the joint.

17. The friction stir welding device of claim 14, wherein the guide member is a first guide member, wherein the second workpiece includes a track that extends along at least a portion of the length of the joint, the friction stir welding device further comprising a second guide member including a clamping face configured to engage the track of the second workpiece, wherein the clamping face of the first guide member is directly opposed to the clamping face of the second guide member to resist separation of the joint.

18. The friction stir welding device of claim 17, further comprising a support member that extends from the first guide member to the second guide member, the support member configured to absorb vertical weld forces incurred by the weld tool during operation of the friction stir welding device.

19. The friction stir welding device of claim 14, wherein the track of the first workpiece includes a rib integrally formed with the first workpiece as a single component.

20. The friction stir welding device of claim 14, wherein the track includes a separate component that is coupled to the workpiece.
